(19) United States
(12) Patent Application Publication
(10) Pub. No.: US 2006/0013256 A1
(43) Pub. Date: Jan. 19, 2006

(54) Wireless communication device and method for aggregating MAC service data units

(75) Inventors: Kab-Joo Lee, Seognam-si (KR); Jae-Sun Choi, Bucheon-si (KR)

Correspondence Address: F. CHAU & ASSOCIATES, LLC, 130 WOODBURY ROAD, WOODBURY, NY, 11797, US

(73) Assignee: Samsung Electronics Co., LTD.

(21) Appl. No.: 11/131,971

(22) Filed: May 18, 2005

(30) Foreign Application Priority Data
Jul. 13, 2004 (KR) 2004-54497

(51) Int. Cl. H04J 3/24

(52) U.S. Cl. 370/473

(57) ABSTRACT

Provided is a wireless communication device and method aggregating MAC service data units (MSDUs). The wireless communication device (STA) can aggregate a plurality of small-sized MSDUs downloaded from an upper layer into one MAC frame in a MAC layer, transmit the aggregated single frame via a physical layer, and receive and process a data frame having the same frame structure transmitted from another communication device. To aggregate MSDUs into a single frame, a MAC frame structure, communication schemes between communication devices and between an AP and a communication device, and a transmission/reception queue management scheme are newly define.

### BACKGROUND OF THE INVENTION

This application claims the priority of Korean Patent Application No. 2004-54497, filed on Jul. 13, 2004, in the Korean Intellectual Property Office, the disclosure of which is incorporated herein in its entirety by reference.

1. Field of the Invention

The present invention relates to a wireless communication station or device, and more particularly, to a wireless communication station and method for communicating by aggregating media access control (MAC) service data units (MSDUs) to improve throughput of a system for IEEE 802.11.

2. Description of the Related Art

FIG. 1 is a conventional MAC data frame comprising an aggregation of MPDUs. FIG. 1 shows a structure of a MAC data frame 10 of a message protocol data unit (MPDU) aggregation method described in the IEEE 802.11e Draft 1.0 (March 2001). The MAC data frame 10 is defined as “container management frame” which can include a plurality of MPDUs downloaded from a logical link control (LLC) layer existing in an upper layer. Even if the MPDUs are aggregated in the MAC data frame 10, since unnecessary header information is included in a MAC header when an MSDU is not fragmented, channel bandwidth is wasted. Here, an MPDU is data downloaded from the LLC layer to a MAC layer, and an MSDU is data obtained by adding a MAC header and a frame check sequence (FCS) to the MPDU to transmit the MPDU to another station in accordance with a MAC protocol.

FIG. 2 is a conventional MAC data frame comprising an aggregation of MSDUs. FIG. 2 shows a structure of a MAC data frame 20 used in a method of aggregating a plurality of MSDUs by generating sub-layers for aggregation in the LLC layer and the MAC layer. In the MAC data frame 20, definition of a new MAC frame is unnecessary. However, many memory copy operations are necessary in a process of fragmenting and combining MSDUs downloaded from the LLC layer and aggregating the combined MSDUs into the MAC data frame 20. Also, since a new MAC frame is not defined, a communication device using the MAC data frame 20 cannot communicate with other communication devices.

The size of an IEEE 802.11 data frame is as follows. The size of an MSDU downloaded from the LLC layer is defined as being a maximum of 2304 bytes (br octets). However, in reality, the sizes of MSDUs downloaded from the LLC layer are mostly less than 2304 bytes and vary with respect to different data types, i.e., file data, audio data, or video data. For example, a size distribution of Ethernet data frames when an Internet protocol (IP) is used is shown in FIG. 3. Referring to FIG. 3, the proportion of frames less than 1000 bytes is around 80%. Since “Preamble”, “Packet Level Control Process (PLCS)”, “MAC Header”, “Distributed Inter-Frame Space (DIFS)”, “Back-off Time”, and “ACK frame” are additionally necessary to transmit one MSDU, if small-sized MSDUs are transmitted more frequently, the efficiency of using a wireless channel bandwidth is dramatically lowered.

### SUMMARY OF THE INVENTION

A wireless communication device is provided for aggregating a plurality of small-sized MSDUs into a MAC frame and transmitting the aggregated MAC frame for raising the efficiency of using a wireless channel bandwidth and for improving throughput in an IEEE 802.11 communication system and a wireless communication system including the wireless communication device.

TA wireless communication method is also provided for using a newly defined MAC frame structure, a communication scheme between an access point (AP) and a station (STA), and a transmission/reception queue management scheme for aggregating a plurality of small-sized MSDUs into a MAC frame.

According to an aspect of the present invention, there is provided a wireless communication method comprising: performing an aggregation addition set operation to aggregate data by negotiating between a first communication device and a second communication device; if the aggregation addition set operation succeeds, (a) communicating between the first communication device and the second communication device using an aggregation data frame, (b) dividing the aggregation data frame into normal data frames, and (c) processing the normal data frames in a communication device which has received the aggregation data frame. The aggregation data frame may include at least one pair of aggregation sub-header (ASH) and MSDU, and when the aggregation data frame includes a plurality of ASHs and a plurality of MSDUs, each ASH may be followed by an MSDU corresponding to the ASH.

The step of performing an aggregation addition set operation may include: transmitting an addition request action frame from a MAC layer of the first communication device to the second communication device via a physical layer; and transmitting an addition response action frame from a MAC layer of the second communication device to the first communication device via the physical layer. The addition request action frame may include a category value indicating the aggregation, an action field value, a maximum aggregation size value, and an aggregation timeout value. The addition response action frame may include a category value indicating the aggregation, an action field value, a maximum aggregation size value, and a response status value.

The step of communicating using the aggregation data frame may include: receiving an MSDU from an upper layer in a MAC layer; generating an aggregation data frame with respect to the MSDU; checking whether a destination of the aggregation data frame is the same as the destination of a previous data frame in a transmission queue; if the previous data frame that has the same destination is an aggregation data frame, and if the size of a new aggregation data frame obtained by aggregating the two aggregation data frames is within a maximum frame size, aggregating the generated aggregation data frame and the previous data frame that has the same destination; and transmitting the aggregated aggregation data frame via a physical layer.

According to another aspect of the present invention, there is provided a wireless communication system comprising a first communication device and a second communication device negotiating aggregation addition with each other, wherein, if an aggregation addition set operation has succeeded, communication is performed between the first communication device and the second communication device using an aggregation data frame, and a communication device which has received the aggregation data frame divides the aggregation data frame into normal data frames and processes the normal data frames. The aggregation data frame may include at least one pair of ASH and MSDU, and when the aggregation data frame includes a plurality of ASHs and a plurality of MSDUs, each ASH may be followed by an MSDU corresponding to the ASH.

According to another aspect of the present invention, there is provided a wireless communication device comprising; a system management entity for managing aggregation addition to be performed with another communication device for which the aggregation addition is set and for managing primitive information to be used for communication with the other communication device for which the aggregation addition is set; a MAC layer generating communication frames for communicating with the other communication device for which the aggregation addition is set using the primitive information; and a physical layer for transmitting to the other communication device and receiving from the other communication device communication signals corresponding to the communication frames, via an air medium.

### BRIEF DESCRIPTION OF THE DRAWINGS

The above and other features and advantages of the present invention will become more apparent by describing in detail exemplary embodiments thereof with reference to the attached drawings in which:

FIG. 1 is a conventional MAC data frame comprising an aggregation of MPDUs;

FIG. 2 is an example of a conventional MAC data frame comprising an aggregation of MSDUs;

FIG. 3 is a pie chart showing a size distribution of Ethernet data frames;

FIG. 4 is a block diagram of an ad-hoc communication network system according to an embodiment of the present invention;

FIG. 5 is a block diagram of an infrastructure communication network system according to an embodiment of the present invention;

FIG. 6 shows an aggregation data frame;

FIG. 7 is a table summarizing primitive request information used to add data to an aggregation data frame;

FIG. 8a is a table summarizing a request frame body used to add data to an aggregation data frame, and FIG. 8b shows a request action frame including the request frame body;

FIG. 9 is a table summarizing primitive tryout information used to add data to an aggregation data frame;

FIG. 10 is a table summarizing primitive confirmation information used to add data to an aggregation data frame;

FIG. 11a is a table summarizing a response frame body used to add data to an aggregation data frame, and FIG. 11b shows a response action frame including the response frame body;

FIG. 12 is a table summarizing primitive request information used to delete data from an aggregation data frame;

FIG. 13a is a table summarizing a request frame body used to delete data from an aggregation data frame, and FIG. 13b shows a request action frame including the request frame body;

FIG. 14 is a table summarizing primitive confirmation information used to delete data from an aggregation data frame;

FIG. 15 is a table summarizing primitive tryout information used to delete data from an aggregation data frame;

FIG. 16a is a table showing a request frame body used when association is set between a communication device and an AP, and FIG. 16b a table showing a response frame body used when the association is set between the communication device and the AP;

FIG. 17a is a table showing a request frame body used when re-association is set between a communication device and the AP, and FIG. 17b a table showing a response frame body used when the re-association is set between the communication device and the AP;

FIG. 18 illustrates a communication method to add data to an aggregation data frame;

FIG. 19 illustrates a communication method to delete data from an aggregation data frame;

FIG. 20 illustrates a communication method to delete data from an aggregation data frame when an operation to add the data to the aggregation data frame has failed;

FIGS. 21a through 21c are examples showing cases where an operation to add data to an aggregation data frame has failed;

FIG. 22 is a flowchart illustrating a transmission management operation in a MAC layer;

FIG. 23 shows a transmission queue of a MAC layer; and

FIG. 24 illustrates a reception management operation in a MAC layer.

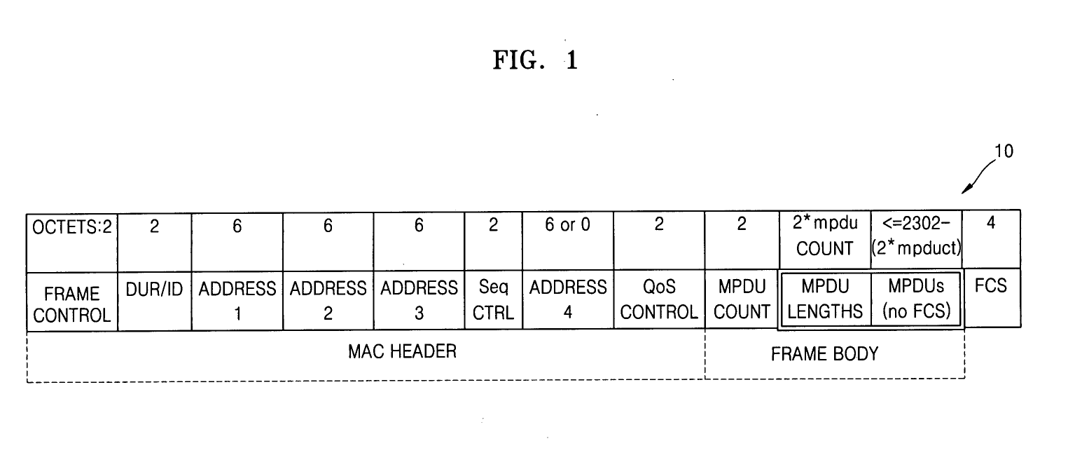

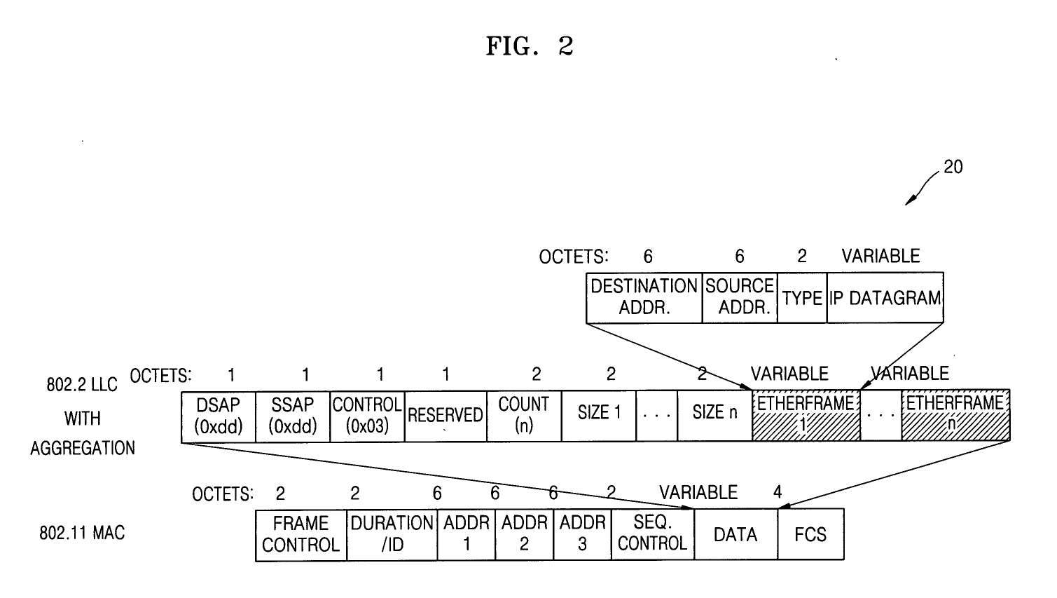

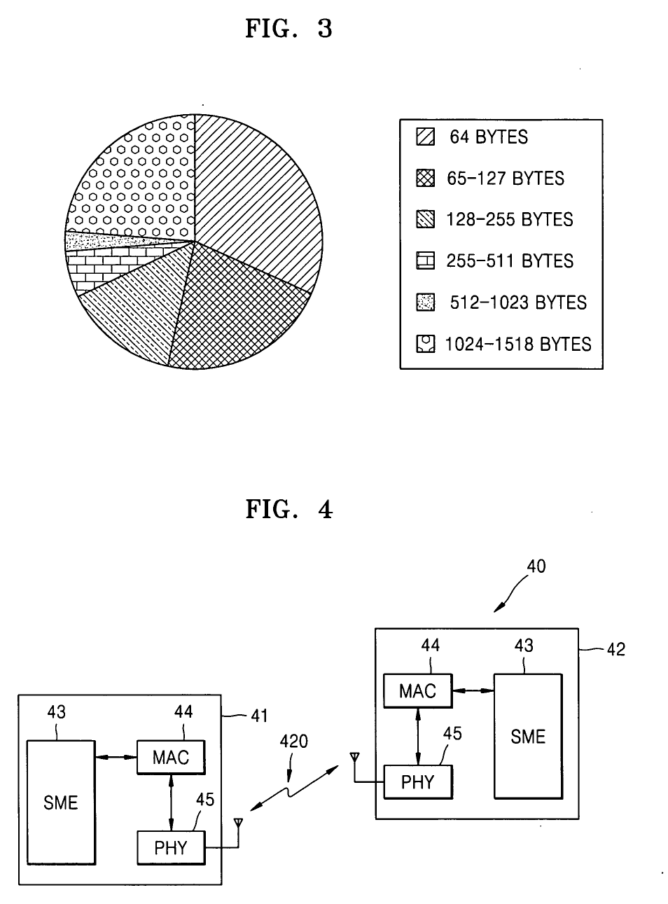

### DETAILED DESCRIPTION OF THE INVENTION

Hereinafter, the present invention will now be described more fully with reference to the accompanying drawings, in which embodiments of the invention are shown. Like reference numbers are used to refer to like elements through at the drawings.

FIG. 4 is a block diagram of an ad-hoc communication network system 40 according to an embodiment of the present invention. Referring to FIG. 4, the ad-hoc communication network system 40 corresponds to a unicast network including a first communication device 41 and a second communication device 42, which perform wireless communication via an air medium 420. The communication devices 41 and 42 may be PCs, cell-phones, or personal digital assistants (PDAs).

In particular, in this embodiment of the present invention, a new communication method using an aggregation of MSDUs (not shown) and an aggregation data frame in a MAC layer 44 is suggested for use in communication between the communication devices 41 and 42.

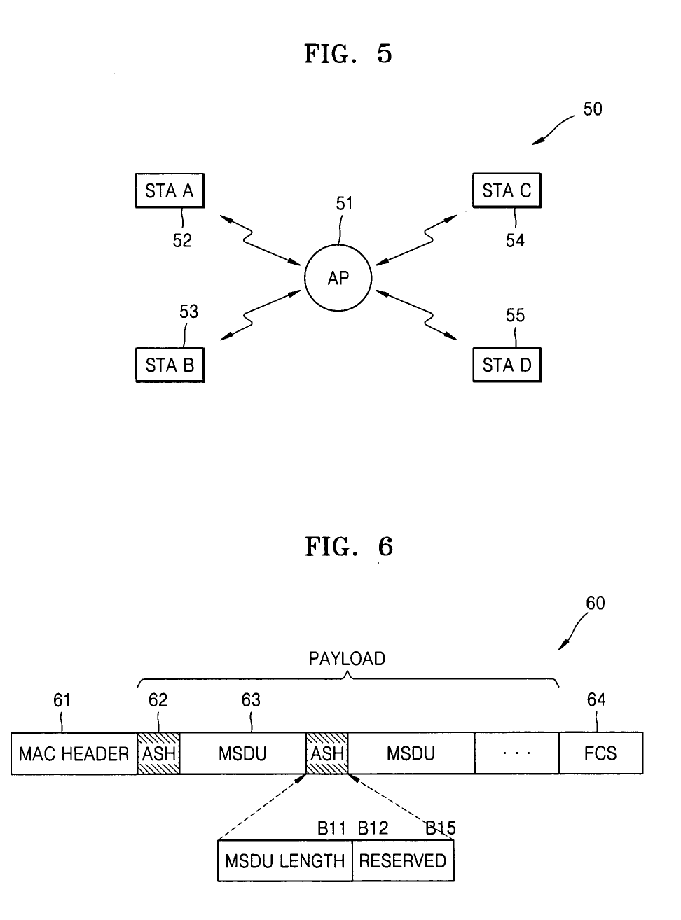

Each of the communication devices 41 and 42 includes a system management entity (SME) 43, a MAC layer 44, and a physical layer 45. In FIG. 5, a block diagram of an infrastructure communication network system 50 including a plurality of communication devices 52 through 55 having the same structure as the communication devices 41 and 42 and an AP 51 relaying communications between the communication devices 52 through 55 is shown. The infrastructure communication network system 50 corresponds to an IP network system. In the present invention, a communication scheme between the communication devices 41 and 42 in the ad-hoc network of FIG. 4 can be applied to communication between the communication devices 52 through 55 and the AP 51 in the infrastructure communication network of FIG. 5.

In FIG. 4, the SME 43 of one communication device manages an operation to add data to an aggregation data frame by communicating with another communication device and also manages primitive information to be used for communication with the other communication device. The MAC layer 44 generates communication frames to be used for communication with the other communication device using the primitive information. The physical layer 45 transmits and receives communication signals corresponding to the communication frames with the other communication device via the air medium 420.

As shown in FIG. 6, an aggregation data frame 60 among the communication frames generated by the MAC layer 44 is newly defined as a pattern of “0xcc” and includes a MAC header 61, at least one or more ASHs 62 and at least one or more MSDUs 63 corresponding to the ASHs in a payload, and a FCS 64. A plurality of small-sized MSDUs 63 downloaded from an upper layer are aggregated into the aggregation data frame 60. When a plurality of ASHs 62 and a plurality of MSDUs 63 are aggregated into the aggregation data frame 60, unlike a conventional method, each ASH 62 is followed by an MSDU 63 corresponding to the ASH 62. The ASH 62 is composed of 2 bytes, 12 bits of which are assigned for storing information on the data size of the corresponding MSDU 63. It is suggested that a maximum aggregation size obtained by aggregating the MSDUs 63 into the aggregation data frame 60 is 4096 bytes, and the maximum aggregation size can be set to different sizes depending on the kind of physical layer 45.

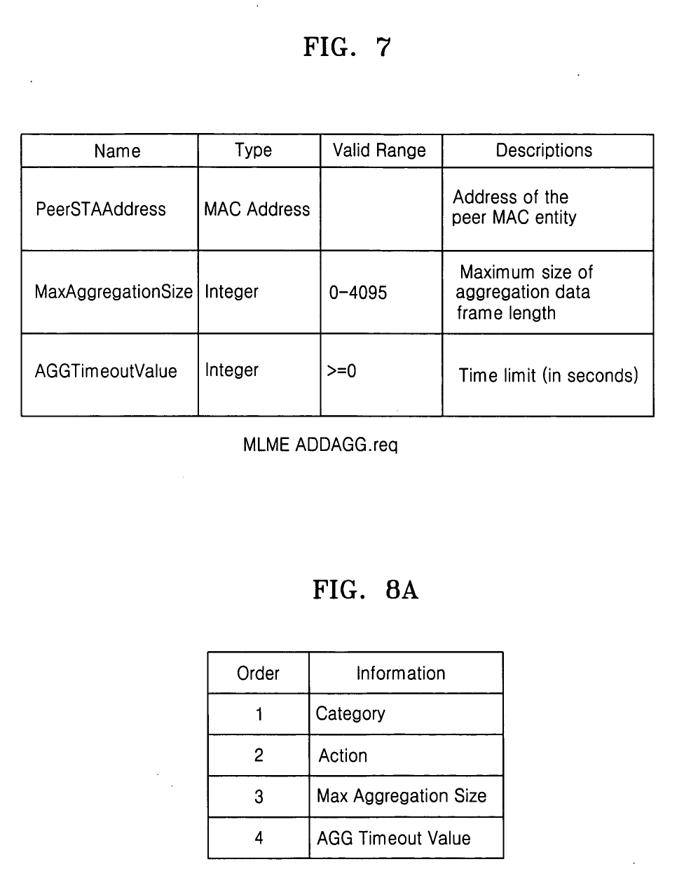

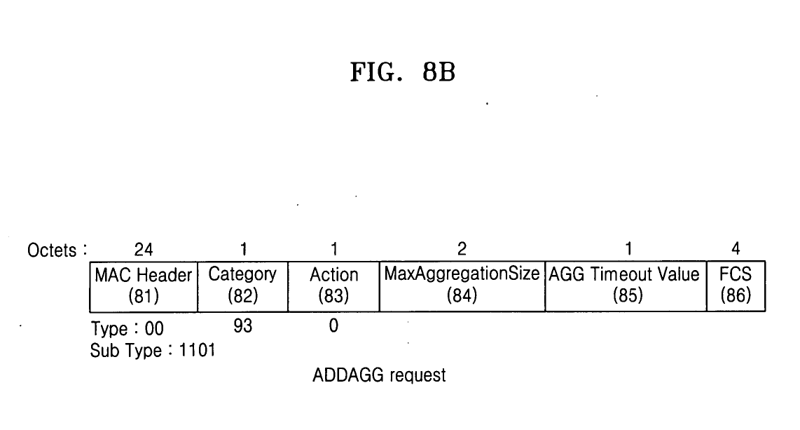

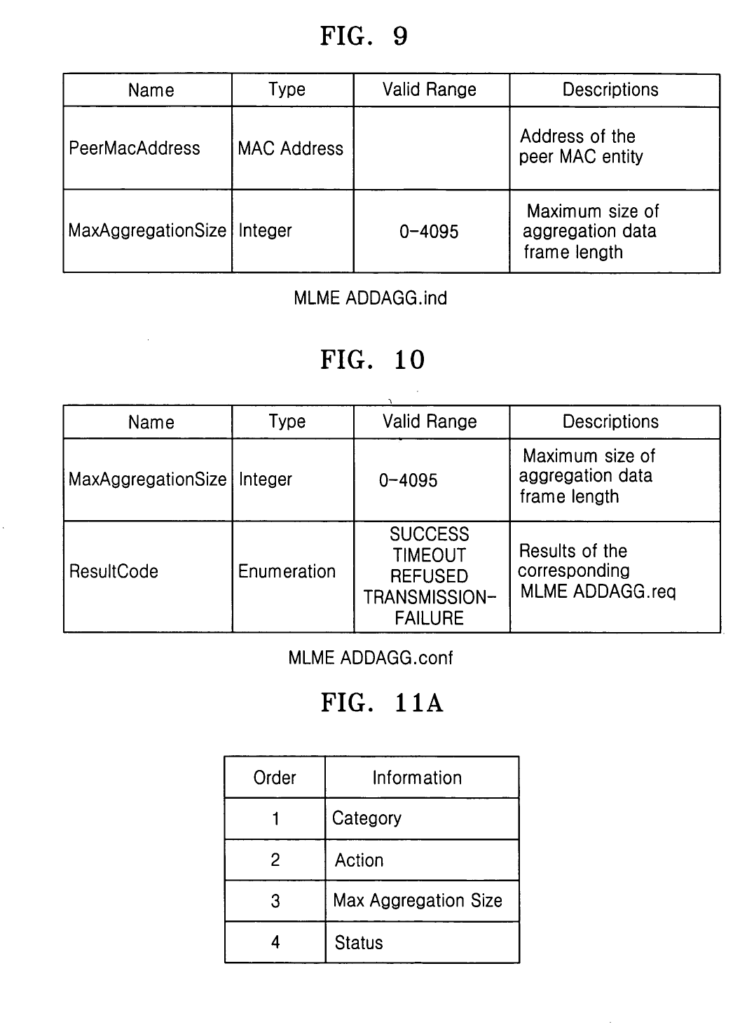

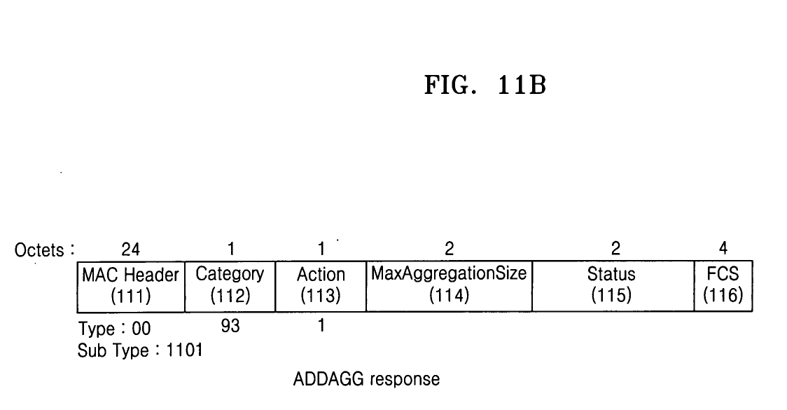

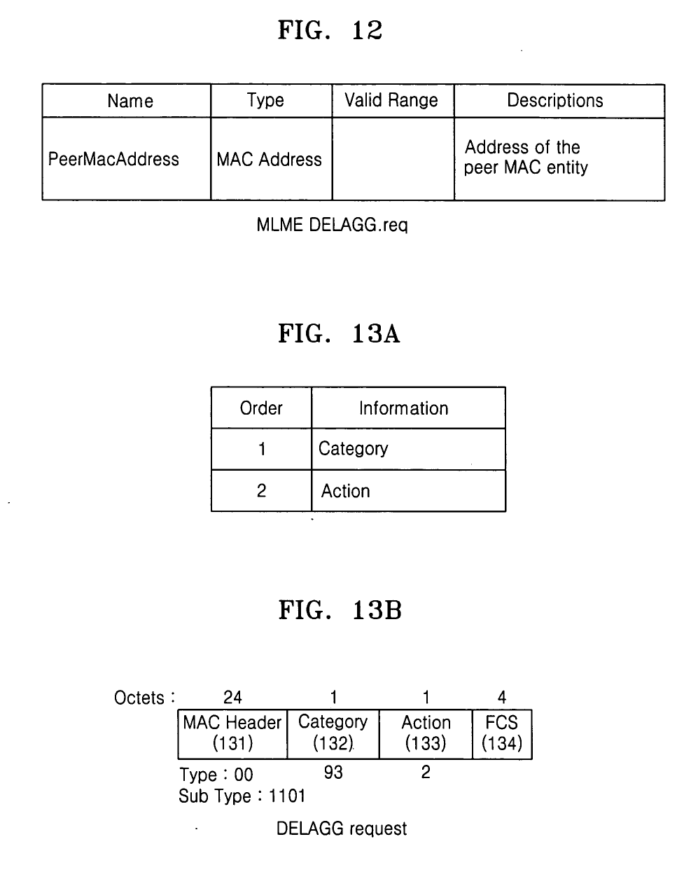

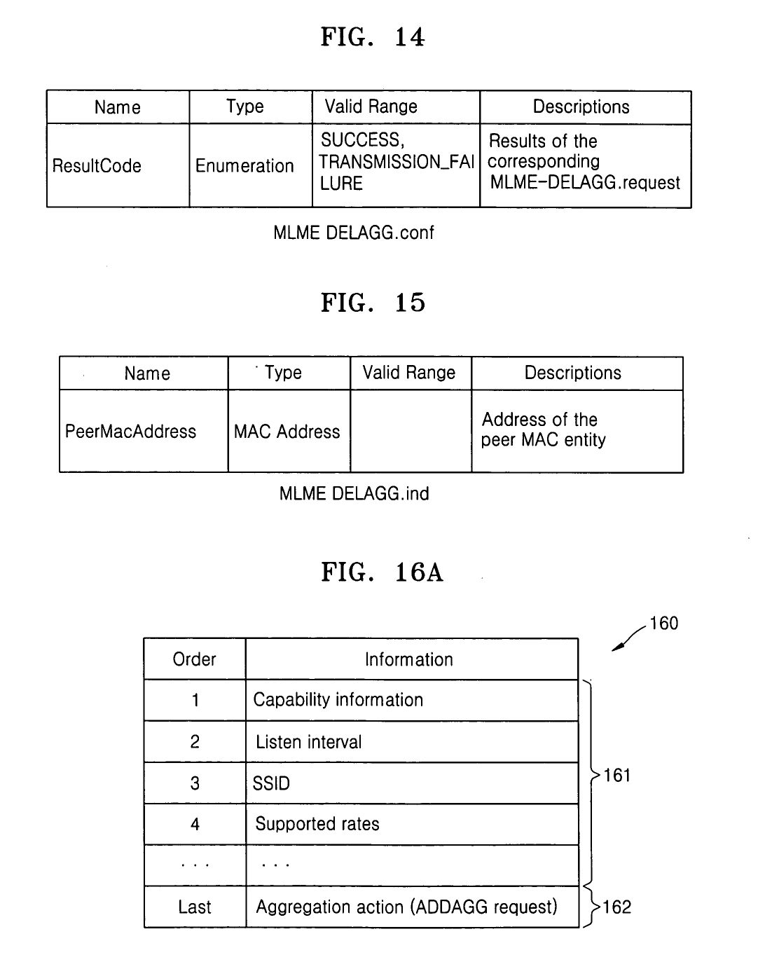

The primitive information managed by the SME 43 includes information used to request addition of data to the aggregation data frame 60 (hereinafter, aggregation addition request information) (refer, for example, to FIG. 7), information used to try addition of data to the aggregation data frame 60 (hereinafter, aggregation addition tryout information) (refer, for example, to FIG. 9), information used to request deletion of data from the aggregation data frame 60 (hereinafter, aggregation release request information) (refer, for example, to FIG. 12), information used to try deletion of data from the aggregation data frame 60 (hereinafter, aggregation release tryout information) (refer, for example, to FIG. 15), information used to confirm addition of data to the aggregation data frame 60 (hereinafter, aggregation addition confirmation information) (refer, for example, to FIG. 10), and information used to confirm deletion of data from the aggregation data frame 60 (hereinafter, aggregation release confirmation information) (refer, for example, to FIG. 14). Among the communication frames generated by the MAC layer 44, an addition request action frame (refer, for example, to FIG. 8b), an addition response action frame (refer, for example, to FIG. 11b), and a deletion request action frame (refer, for example, to FIG. 13b) are respectively generated with reference to the aggregation addition request information (refer, for example, to FIG. 7), the aggregation addition tryout information (refer, for example, to FIG. 9), and the aggregation release request information (refer, for example, to FIG. 12) among the primitive information.

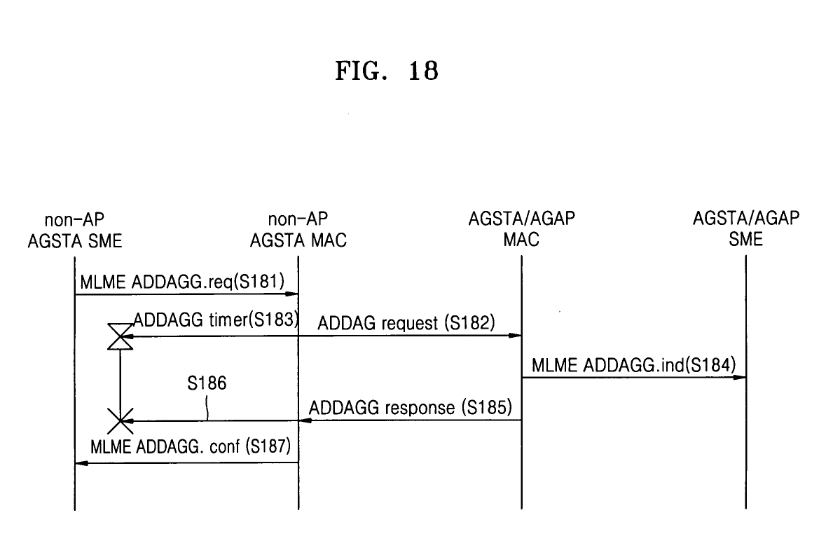

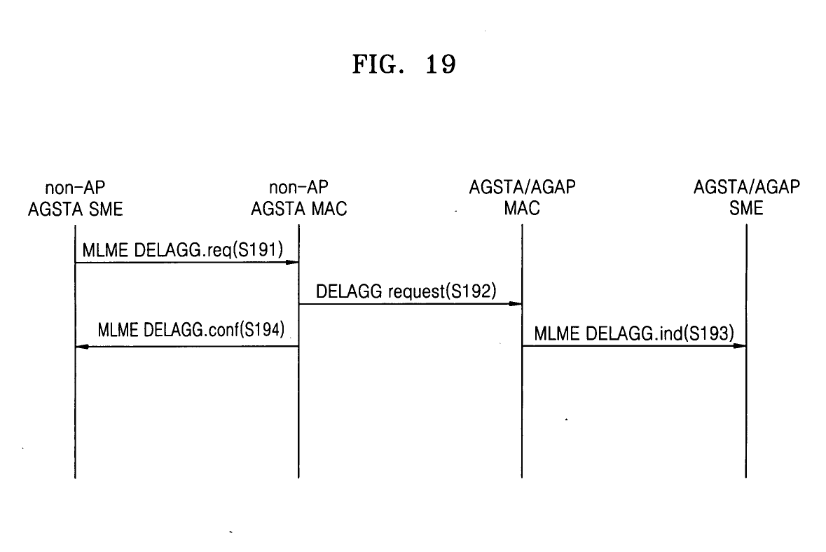

A communication scheme performed between communication devices using MAC frames including the aggregation data frame 60 described above will now be described with reference to FIGS. 18 through 21.

Referring to FIG. 18, in a negotiation to add data to the aggregation data frame 60, a SME 43 of a first communication device (non-AP AGSTA) transmits aggregation addition request information (MLME ADDAGG.req) to a MAC layer 44 of the non-AP AGSTA in operation S181, and the MAC layer 44 of the non-AP AGSTA transmits an addition request action frame (ADDAGG request) to a second communication device (AGSTA/AGAP) via a physical layer 45 of the non-AP AGSTA in operation S182. Here, it is assumed that the non-AP AGSTA is an STA supporting aggregation and not an AP 51, and it is further assumed that the AGSTA/AGAP is an STA supporting aggregation or an AP 51. When the ADDAGG request is transmitted to the AGSTA/AGAP, a predetermined timer of the non-AP AGSTA operates, checks a time, and waits for whether an addition response action frame (ADDAGG response) is transmitted from the AGSTA/AGAP within a predetermined time limit in operations S185 and S186. In the AGSTA/AGAP, a MAC layer 44 of the AGSTA/AGAP generates aggregation addition tryout information (MLME ADDAGG.ind) in response to the ADDAGG request received from the non-AP AGSTA and transmits the MLME ADDAGG.ind to an SME 43 of the AGSTA/AGAP in operation S184. Also, the MAC layer 44 of the AGSTA/AGAP generates the ADDAGG response and transmits the ADDAGG response to the non-AP AGSTA in operation S185. Accordingly, the MAC layer 44 of the non-AP AGSTA informs the SME 43 of the non-AP AGSTA whether setup for the aggregation addition with the AGSTA/AGAP has succeeded by transmitting aggregation addition confirmation information (MLME ADDAGG.conf) to the SME 43 of the non-AP AGSTA in operation S187.

Referring to FIG. 8b, the addition request action frame (ADDAGG request) includes an MAC header 81, a category 82 indicating that the ADDAGG request is a data frame requesting for aggregation, an action field value 83, a maximum aggregation size 84, an aggregation timeout value 85, and an FCS 86, according to the order shown in FIG. 8a. As shown in FIG. 8b, in the MAC header 81 of the ADDAGG request, a management type can be defined as “00”, and a sub type indicating an action can be defined as “1101”. As shown in FIGS. 11b and 13b, in the addition response action frame (ADDAGG response) and release request action frame (DELAGG request), the types of MAC headers 111 and 131 are the same as the MAC header 81 of FIG. 8b. The aggregation addition request information (MLME ADDAGG.req) used to generate the ADDAGG request includes an address (PeerSTMddress) of a MAC layer 44 of a destination to be peered, a maximum size (MaxAggregationSize) of an aggregation data frame 60, and a predetermined time limit (AGGTimeoutValue) used to finish an aggregation request when there is no communication with the MAC layer 44 of the destination to be peered for a predetermined time as shown in FIG. 7. As shown in FIG. 8b, a category table value of “93” is defined for the category 82, and an aggregation action table value of “0” is defined for the action field value 83. Table 1 below shows category table values, and Table 2 below shows aggregation action table values.

Referring to FIG. 11b, the addition response action frame (ADDAGG response) includes the MAC header 111, a category 112 indicating that the ADDAGG response is a data frame responding to the aggregation request, an action field value 113, a maximum aggregation size 114, a response status 115, and an FCS 116, according to the order shown in FIG. 11a. The aggregation addition tryout information (MLME ADDAGG.ind) used to generate the ADDAGG response includes an address (PeerMacAddress) of a MAC layer 44 of a destination to be peered and a maximum size. (MaxAggregationSize) of an aggregation data frame 60 as shown in FIG. 9. The aggregation addition confirmation information (MLME ADDAGG.conf) with which it is determined whether aggregation between the non-AP AGSTA and the AGSTA/AGAP has succeeded includes one of “SUCCESS”, “TIMEOUT”, “REFUSED”, and “TRANSMISSION-FAILURE”, which is a result (ResultCode) responding to the MLME ADDAGG.req, and a maximum size (MaxAggregationSize) of an aggregation data frame 60 as shown in FIG. 10.

TABLE 1

| Code | Meaning |
|---|---|
| 0 | Spectrum Management |
| 1 | QoS |
| 2 | DLP |
| 3 | BLK Ack |
| 4-92 | Reserved |
| 93 | Aggregation |
| 94-127 | Reserved |
| 128-255 | Error |

TABLE 2

| Code | Meaning |
|---|---|
| 0 | Spectrum Management |
| 1 | QoS |
| 2 | DLP |
| 3 | BLK Ack |
| 4-92 | Reserved |
| 93 | Aggregation |
| 94-127 | Reserved |
| 128-255 | Error |

FIG. 19 illustrates a communication method to delete data from an aggregation data frame 60. Referring to FIG. 19, the aggregation release can be set by negotiating between the first communication device (non-AP AGSTA) and the second communication device (AGSTA/AGAP). To set the aggregation release, the SME 43 of the non-AP AGSTA transmits aggregation release request information (MLME DELAGG.req) to the MAC layer 44 of the non-AP AGSTA in operation S191, and the MAC layer 44 of the non-AP AGSTA transmits a release request action frame (DELAGG request) to the AGSTA/AGAP via the physical layer 45 of the non-AP AGSTA in operation S192. At this time, the MAC layer 44 of the non-AP AGSTA informs the SME 43 of the non-AP AGSTA that the aggregation release is preformed by transmitting aggregation release confirmation information (MLME DELAGG.conf) to the SME 43 of the non-AP AGSTA in operation S194. Also, in the AGSTA/AGAP, the MAC layer 44 of the AGSTA/AGAP generates aggregation release tryout information (MLME DELAGG.ind) in response to the DELAGG request received from the non-AP AGSTA and transmits the MLME DELAGG.ind to the SME 43 of the AGSTA/AGAP in operation S193.

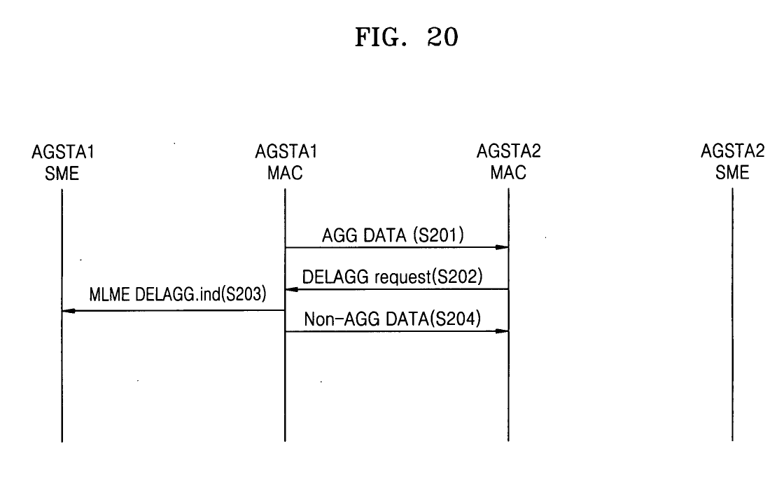

FIG. 20 shows a scheme of preventing an aggregation data frame 60 from being transmitted when aggregation addition setup has failed. For example, when the aggregation addition setup has failed as procedures shown in FIG. 18, if a first communication device (AGSTA1) transmits an aggregation data frame 60 (AGG DATA) to a second communication device (AGSTA2) in operation S201 of FIG. 20, the AGSTA2 sets aggregation release by negotiating with the AGSTA1 in operations S202 through S204. That is, through the negotiation to set the aggregation release, a MAC layer 44 of the AGSTA2 transmits a release request action frame (DELAGG request) to the AGSTA1 via a physical layer 45 of the AGSTA2 in operation 202. At this time, a MAC layer 44 of the AGSTA1 informs an SME 43 of the AGSTA1 of the aggregation release by transmitting aggregation release tryout information (MLME DELAGG.ind) to the SME 43 of the AGSTA1 in operation S203. Accordingly, the AGSTA1 does not transmit an aggregation data frame 60 any more in operation S204.

Referring to FIG. 13b, the release request action frame (DELAGG request) includes a MAC header 131, a category 132 indicating aggregation, an action field value 133, and an FCS 134, according to the order of FIG. 13a. The aggregation release request information (MLME DELAGG.req) for generating the DELAGG request includes an address (PeerMacAddress) of a MAC layer 44 of a destination to be peered as shown in FIG. 12. The aggregation release confirmation information (MLME DELAGG.conf) with which it is determined whether aggregation between communication devices has been released includes one of “SUCCESS” and “TRANSMISSION-FAILURE”, which is a result (ResultCode) responding to the MLME DELAGG.req, as shown in FIG. 14. Also, the aggregation release tryout information (MLME DELAGG.ind) indicating aggregation with a communication partner includes an address (PeerMacAddress) of a MAC layer 44 of a destination to be peered as shown in FIG. 15.

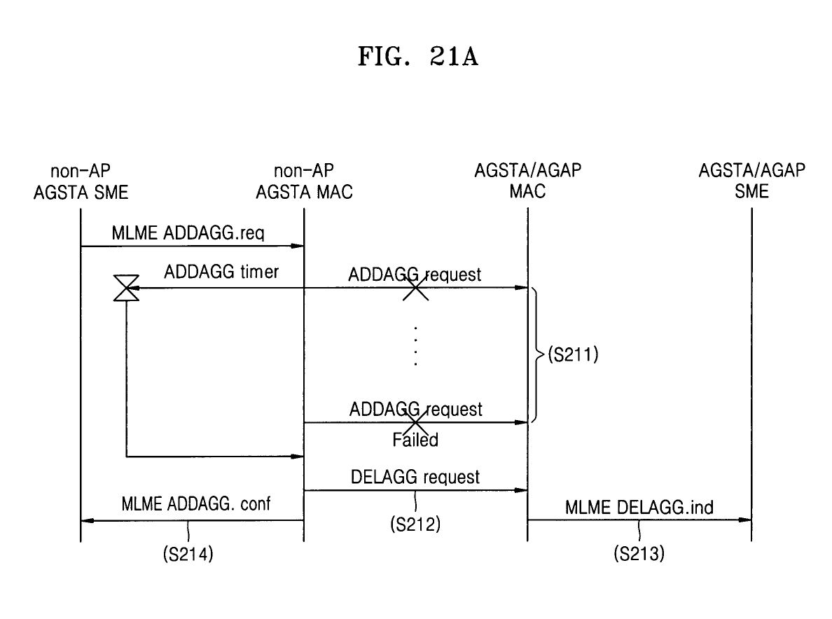

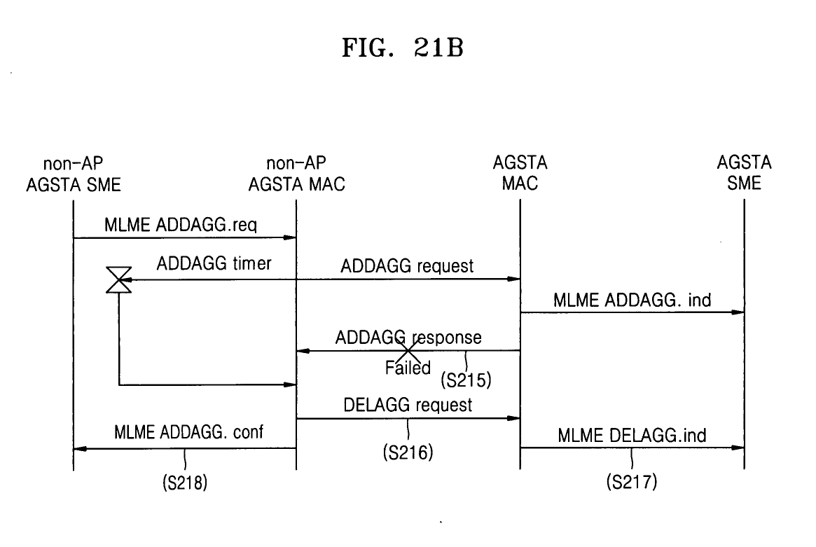

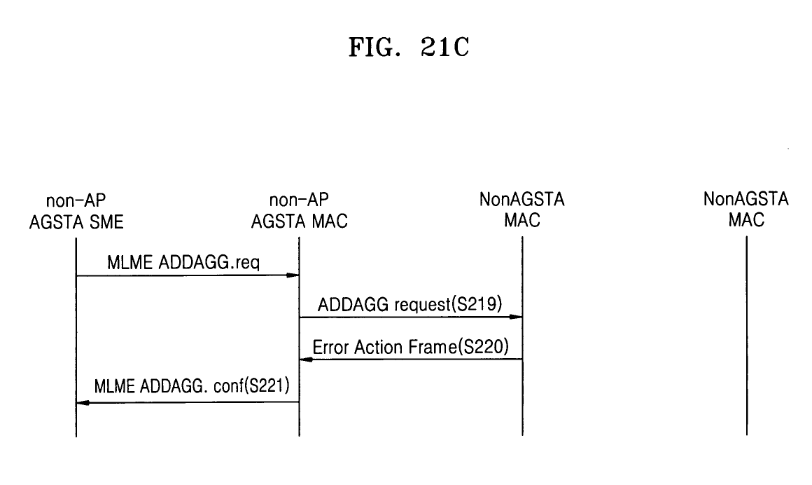

FIG. 21a is a communication scheme showing when a transmission failure of the addition request action frame (ADDAGG request) is generated. If the first communication device (non-AP AGSTA) does not receive the addition response action frame (ADDAGG response) from the second communication device (AGSTA/AGAP) in the negotiation to set the aggregation addition as shown in FIG. 18, the non-AP AGSTA transmits the ADDAGG request repeatedly within the time limit in operation S211. At this time, if the setup for the aggregation addition between the non-AP AGSTA and the AGSTA/AGAP has failed within the time limit, the non-AP AGSTA transmits the release request action frame (DELAGG request) to the AGSTA/AGAP in operation S212. At this time, the MAC layer 44 of the non-AP AGSTA informs the SME 43 of the non-AP AGSTA that the aggregation with the AGSTA/AGAP has failed by transmitting the aggregation addition confirmation information (MLME ADDAGG.conf) including a transmission failure to the SME 43 of the non-AP AGSTA in operation S214. Also, in the AGSTA/AGAP, the MAC layer 44 of the AGSTA/AGAP generates aggregation release tryout information (MLME DELAGG.ind) in response to the DELAGG request received from the non-AP AGSTA and transmits the MLME DELAGG.ind to the SME 43 of the AGSTA/AGAP in operation S213.

FIG. 21b is a communication scheme showing when the addition response action frame (ADDAGG response) has not been received from the second communication device (AGSTA/AGAP) by the first communication device (non-AP AGSTA) within the time limit. When the setup for the aggregation addition is performed as shown in FIG. 18, if transmission of the addition request action frame (ADDAGG request) from the non-AP AGSTA to the AGSTA/AGAP has succeeded, and if the non-AP AGSTA has not been received the ADDAGG response from the AGSTA/AGAP within the time limit in operation S215, the non-AP AGSTA transmits the release request action frame (DELAGG request) to the AGSTA/AGAP in operation S216 in the manner of FIG. 21a. The other operations S217 and S218 are the same as the operations S213 and S214 of FIG. 21a;

FIG. 21c is a communication scheme showing when the second communication device (AGSTA/AGAP) does not have capability for supporting an aggregation function. When the setup for the aggregation addition is performed as shown in FIG. 18, if the first communication device (non-AP AGSTA) transmits the addition request action frame (ADDAGG request) to the AGSTA/AGAP in operation S219, the AGSTA/AGAP transmits a predetermined error action frame to the non-AP AGSTA in operation S220. Accordingly, the MAC layer 44 of the non-AP AGSTA informs the SME 43 of the non-AP AGSTA that the aggregation with the AGSTA/AGAP has failed by transmitting the aggregation addition confirmation information (MLME ADDAGG.conf) including a transmission failure to the SME 43 of the non-AP AGSTA in operation S221.

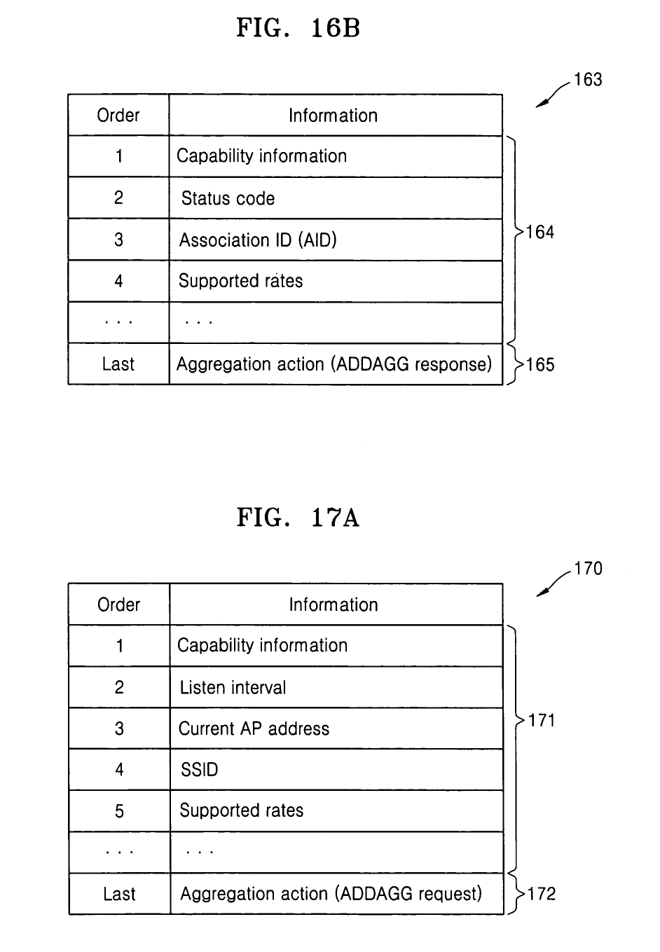

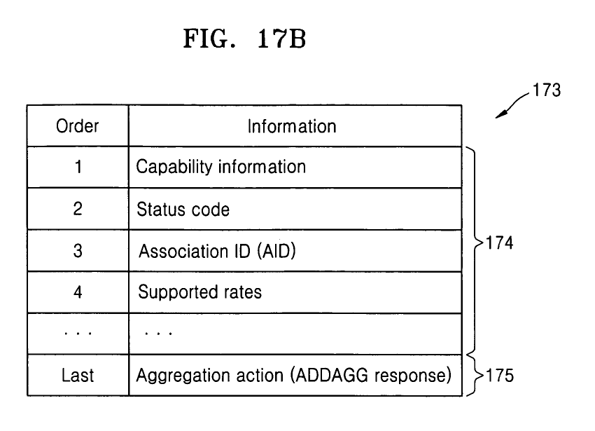

In the wireless communication system having the infrastructure shown in FIG. 5, aggregation addition can be set between the communication devices 52 through 55 and the AP 51, and communication between the communication devices 52 through 55 and the AP 51 can be performed using an aggregation data frame 60. That is, the AP 51 can determine whether it uses an aggregation function when association or re-association is set. In detail, when association between one of the communication devices 52 through 55 and the AP 51 is set, in the communication device, the MAC layer 44 transmits an association request frame body 160 including an aggregation action element 162 shown in FIG. 16a to the AP 51 via the physical layer 45, and in response to this, the AP 51 transmits an association response frame body 163 including an aggregation action element 165 shown in FIG. 16b to the communication device. As shown in FIGS. 16a and 16b, in the association request frame body 166 or the association response frame body 163, each action element for aggregation addition is added as a last element 162 or 165 of each frame body 160 or 163, and if this element does not exist, it is considered that the communication device or the AP 51 does not support the frame aggregation. In FIGS. 16a and 16b, the other elements 161 and 164 are well known to those skilled in the art. In particular, the action element 162 to request the aggregation addition in the association request frame body 160 includes the maximum aggregation size 84 and the aggregation timeout value 85 among information of the addition request action frame (ADDAGG request), and the action element 165 to respond to the aggregation addition in the association response frame body 163 includes the maximum aggregation size 114 and the response status 115 among information of the addition response action frame (ADDAGG response). Also, when re-association to update information between one of the communication devices 52 through 55 and the AP 51 is set, the communication device transmits a re-association request frame body 170 including an aggregation action element 172 shown in FIG. 17a to the AP 51, and in response to this, the AP 51 transmits a re-association response frame body 173 including an aggregation action element 175 shown in FIG. 17b to the communication device. Likewise, in FIGS. 17a and 17b, the other elements 171 and 174 are well known to those skilled in the art. Also, the action element 172, for requesting the aggregation addition in the re-association request frame body 170, includes the maximum aggregation size 84 and the aggregation timeout value 85 among information of the addition request action frame (ADDAGG request), and the action element 175, for responding to the aggregation addition in the re-association response frame body 173, includes the maximum aggregation size 114 and the response status 115 among information of the addition response action frame (ADDAGG response).

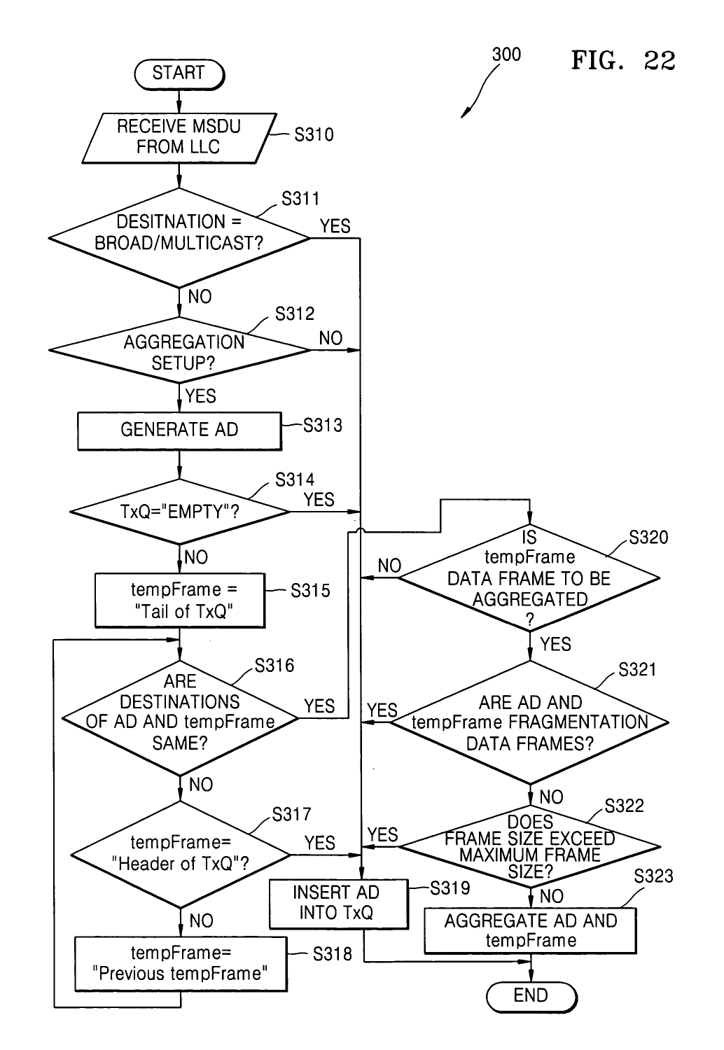

A transmission/reception management operation of an aggregation data frame 60 in a MAC layer 44 will now be described with reference to FIGS. 22 through 24.

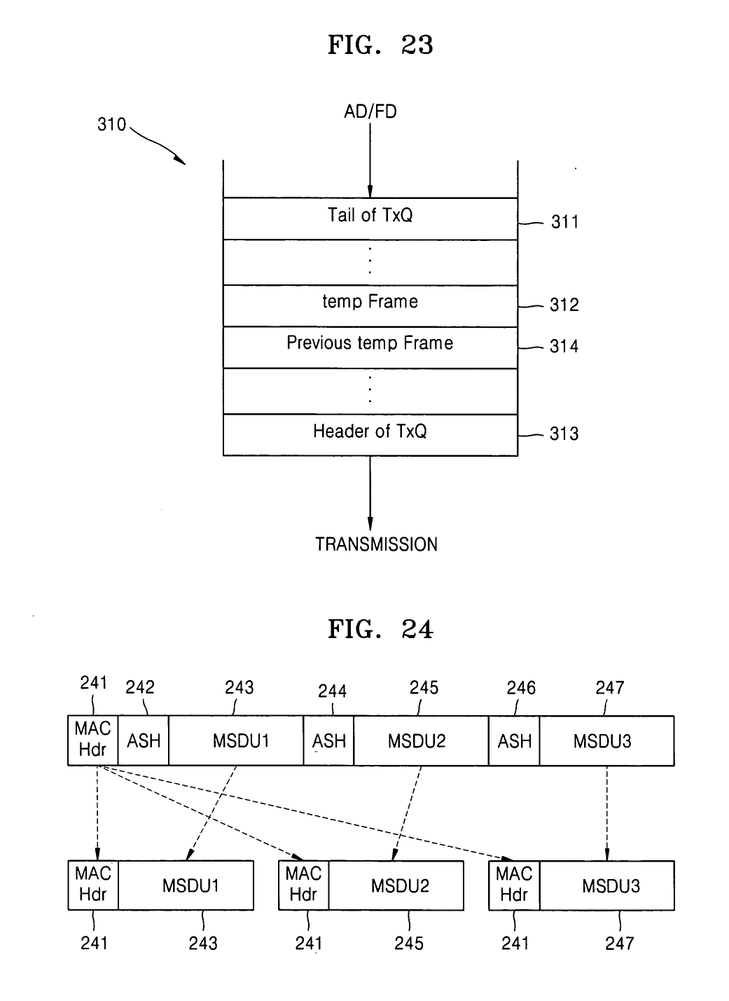

Referring to FIGS. 22 and 23, a MAC layer 44 receives an MSDU from an LLC layer, which is an upper layer, in operation S310. The MAC layer 44 determines whether a destination is based on “broadcast or multicast” from an address of the destination in operation S311. If the destination is based on “unicast”, the MAC layer 44 determines whether aggregation addition is set for the destination in operation S312. That is, the MAC layer 44 determines whether aggregation addition is set with reference to the process described in FIG. 18 or in the association request frame body 160 shown in FIG. 16a. If setup for aggregation is performed, an aggregation data frame (AD) having the structure as shown in FIG. 6 is generated with respect to the currently-received MSDU in operation S313. The MAC layer 44 determines whether a transmission queue 310 is empty in operation S314. If the transmission queue 310 is empty, the generated AD is inserted in a transmission queue header 313 in operation S319. The transmission queue header 313 is transmitted before a transmission queue tail 311. If the transmission queue 310 is not empty, the transmission queue tail 311 is defined as a temporary frame (tempFrame) 312 in operation S315. The MAC layer 44 determines whether the destination of the generated AD is the same as that of the tempFrame 312 in operation S316. If the destination of the generated AD is the same as that of the tempFrame 312, aggregation procedures S320 through S323 are performed, and if the destination of the generated AD is not the same as that of the tempFrame 312, the MAC layer 44 repeatedly determines whether the destination of the generated AD is the same as that of at least one of previous frames in the transmission queue 310 in operations S316 through S318. That is, if the tempFrame 312 is the transmission queue header 313 in operation S317, the generated AD is inserted in the transmission queue header 313 in operation S319. Otherwise, a previous frame 314 is defined as the tempFrame 312 in operation S318, and the process returns to operation S316.

If the destination of the generated AD is the same as that of the tempFrame 312 in operation S316, the MAC layer 44 repeatedly determines whether the tempFrame 312 is an aggregation data frame having the structure as shown in FIG. 6 in operation S320. At this time, if the generated AD and the tempFrame 312 are not fragmentation frames (FDs) in operation S321, and if a size of an aggregation data frame 60 to be obtained by aggregating the generated AD and the tempFrame 312 is within a maximum frame size in operation S322, the MAC layer 44 generates the aggregation data frame 60 by aggregating the generated AD and the tempFrame 312 into the structure shown in FIG. 6 in operation S323. When an aggregation data frame 60 is generated in the MAC layer 44 according to the process described above, the aggregation data frame 60 is transmitted to another communication device via a physical layer 45.

FIG. 24 illustrates a reception management operation in a MAC layer 44. When an aggregation data frame 60 is generated and transmitted according to the process described in FIG. 22, a communication device receiving the aggregation data frame 60 divides the aggregation data frame 60 into normal data frames using ASHs and processes the normal data frames. For example, when the aggregation data frame 60 extracted from a MAC layer 44 includes a MAC header 241, a first ASH 242 and a first MSDU 243 corresponding to the first ASH 242, a second ASH 244 and a second MSDU 245 corresponding to the second ASH 244, and a third ASH 246 and a third MSDU 247 corresponding to the third ASH 246, the MAC layer 44 transmits the normal data frames, in which each of the first MSDU 243, the second MSDU 245, and the third MSDU 247 is attached to the MAC header 241 to an upper layer.

As described above, a communication device according to an embodiment of the present invention can aggregate a plurality of small-sized MSDUs downloaded from an upper layer into one. MAC frame in a MAC layer, transmit the aggregated single frame via a physical layer, and receive and process a data frame having the same frame structure as that transmitted from another communication device. To aggregate MSDUs into a single frame, a MAC frame structure, communication schemes between communication devices and between an AP and a communication device, and a transmission/reception queue management scheme are newly defined.

The communication device can perform IEEE 802.11 communication with general-use devices using the newly defined MAC frame structure, communication schemes between communication devices and between an AP and a communication device, and a transmission/reception queue management scheme. Also, according to a method of transmitting and receiving a single aggregation frame, the efficiency of using a wireless channel bandwidth can be raised, and throughput can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A wireless communication method comprising:
performing an aggregation addition set operation to aggregate data by negotiating between a first communication device and a second communication device; and
if the aggregation addition set operation succeeds, (a) communicating between the first communication device and the second communication device using an aggregation data frame, (b) dividing the aggregation data frame into normal data frames, and (c) processing the normal data frames in a communication device which has received the aggregation data frame.

2. The method of claim 1, wherein the aggregation data frame comprises at least one pair of aggregation sub-header (ASH) and MAC service data unit (MSDU), and when the aggregation data frame comprises a plurality of ASHs and a plurality of MSDUs, each ASH is followed by an MSDU corresponding to the ASH.

3. The method of claim 1, wherein the step of performing an aggregation addition set operation comprises:
transmitting an addition request action frame from a MAC layer of the first communication device to the second communication device via a physical layer; and
transmitting an addition response action frame from a MAC layer of the second communication device to the first communication device via the physical layer.

4. The method of claim 3, wherein the addition request action frame comprises a category value indicating the aggregation, an action field value, a maximum aggregation size value, and an aggregation timeout value.

5. The method of claim 3, wherein the addition response action frame comprises a category value indicating the aggregation, an action field value, a maximum aggregation size value, and a response status value.

6. The method of claim 1, wherein the step of communicating using the aggregation data frame comprises:
receiving an MSDU from an upper layer in a MAC layer;
generating an aggregation data frame with respect to the MSDU;
checking whether a destination of the aggregation data frame is the same as the destination of a previous data frame in a transmission queue;
if the previous data frame that has the same destination is an aggregation data frame, and if the size of a new aggregation data frame obtained by aggregating the two aggregation data frames is within a maximum frame size, aggregating the generated aggregation data frame and the previous data frame that has the same destination; and
transmitting the aggregated aggregation data frame via a physical layer.

7. The method of claim 1, further comprising:
performing an application release set operation to delete data from the aggregated by negotiating between the first communication device and the second communication device.

8. The method of claim 7, wherein in the application release set operation,
when the aggregation addition set operation has failed, if the first communication device transmits an aggregation data frame to the second communication device, the second communication device performs the aggregation release set operation by negotiating with the first communication device.

9. The method of claim 1, further comprising:
setting an association between an access point (AP) and one of the first communication device and the second communication device, the AP relaying communication between the first communication device and the second communication device,
wherein the step of setting an association comprises:
transmitting an association request frame body from a MAC layer of the one of the first communication device and the second communication device to the AP via a physical layer; and
transmitting an association response frame body from the AP to the one of the first communication device and the second communication device in response to the association request frame body.

10. The method of claim 9, wherein the association request frame body comprises a maximum aggregation size value and an aggregation timeout value, and the association response frame body comprises a maximum aggregation size value and a response status value.

11. The method of claim 9, further comprising:
setting a re-association between the AP and one of the first communication device and the second communication device in the AP relaying communication between the first communication device and the second communication device,
wherein the step of setting a re-association comprises:
transmitting a re-association request frame body from a MAC layer of the one of the first communication device and the second communication device to the AP via a physical layer; and
transmitting a re-association response frame body from the AP to the one of the first communication device and the second communication device in response to the re-association request frame body.

12. The method of claim 11, wherein the re-association request frame body comprises a maximum aggregation size value and an aggregation timeout value, and the re-association response frame body comprises a maximum aggregation size value and a response status value.

13. A wireless communication system comprising a first communication device and a second communication device negotiating aggregation addition with each other,
wherein, if an aggregation addition set operation has succeeded, communication is performed between the first communication device and the second communication device using an aggregation data frame, and a communication device which has received the aggregation data frame divides the aggregation data frame into normal data frames and processes the normal data frames.

14. The system of claim 13, wherein the aggregation data frame comprises at least one pair of ASH and MSDU, and when the aggregation data frame comprises a plurality of ASHs and a plurality of MSDUs, each ASH is followed by an MSDU corresponding to the ASH.

15. The system of claim 13, wherein in the first communication device, a MAC layer transmits an addition request action frame to the second communication device via a physical layer when the aggregation addition set operation is performed, and in the second communication device, a MAC layer transmits an addition response action frame to the first communication device via a physical layer in response to the addition request action frame.

16. The system of claim 15, wherein the addition request action frame comprises a category value indicating the aggregation, an action field value, a maximum aggregation size value, and an aggregation timeout value.

17. The system of claim 15, wherein the addition response action frame comprises a category value indicating the aggregation, an action field value, a maximum aggregation size value, and a response status value.

18. The system of claim 13, wherein an aggregation release set operation is performed by negotiating between the first communication device and the second communication device, and when the aggregation addition set operation fails, if the first communication device transmits the aggregation data frame to the second communication device, the second communication device performs the aggregation release set operation by negotiating with the first communication device.

19. The system of claim 13, further comprising:
an access point (AP) relaying communication between the first communication device and the second communication device.

20. The system of claim 19, wherein communication is performed between the communication devices and the AP using the aggregation data frame generated by the aggregation addition set operation.

21. The system of claim 20, wherein, when association is set between one of the communication devices and the AP, a MAC layer of the communication device transmits an association request frame body to the AP via a physical layer of the one of the communication devices, and the AP transmits an association response frame body to the one of the communication devices in response to the association request frame body, and
when re-association is set between the one of the communication devices and the AP, a MAC layer of the one of the communication devices transmits a re-association request frame body to the AP via a physical layer of the one of the communication devices, and the AP transmits a re-association response frame body to the one of the communication devices in response to the re-association request frame body.

22. The system of claim 21, wherein each of the association request frame body and the re-association request frame body comprises a maximum aggregation size value and an aggregation timeout value, and each of the association response frame body and the re-association response frame body comprises a maximum aggregation size value and a response status value.

23. A wireless communication device comprising:
a system management entity for managing aggregation addition to be performed with another communication device for which the aggregation addition is set and for managing primitive information to be used for communication with the other communication device for which the aggregation addition is set;
a MAC layer generating communication frames for communicating with the other communication device for which the aggregation addition is set using the primitive information; and
a physical layer for transmitting to the other communication device and receiving from the other communication device communication signals corresponding to the communication frames, via an air medium.

24. The wireless communication device of claim 23, wherein the primitive information comprises aggregation addition request information, aggregation addition tryout information, aggregation release request information, aggregation release tryout information, aggregation addition confirmation information, and aggregation release confirmation information.

25. The wireless communication device of claim 24, wherein the communication frames comprise an aggregation data frame, an addition request action frame corresponding to the aggregation addition request information, an addition response action frame corresponding to the aggregation addition tryout information, and a release request action frame corresponding to the aggregation release request information.

26. The wireless communication device of claim 25, wherein the aggregation data frame comprises at least one pair of ASH and MSDU, and when the aggregation data frame comprises a plurality of ASHs and a plurality of MSDUs, each ASH is followed by an MSDU corresponding to the ASH.

27. The wireless communication device of claim 26, wherein the MAC layer performs aggregation addition setup with an access point (AP) by one of (a) generating an association request frame body and an association response frame body when association with the AP is set, and (b) generating a re-association request frame body and a re-association response frame body when re-association with the AP is set, and wherein the MAC layer communicates with the aggregation-addition-set AP via the physical layer using the aggregation data frame.
